(19) United States
(12) Patent Application Publication
(10) Pub. No.: US 2024/0371354 A1
(43) Pub. Date: Nov. 7, 2024

(54) ACTIVE NOISE CONTROL APPARATUS FOR A VEHICLE AND A CONTROL METHOD THEREFOR

(71) Applicant: HYUNDAI MOBIS CO., LTD., Seoul (KR)

(72) Inventor: Hyung Sub LIM, Suwon-si (KR)

(73) Assignee: HYUNDAI MOBIS CO., LTD., Seoul (KR)

(21) Appl. No.: 18/632,388

(22) Filed: Apr. 11, 2024

(30) Foreign Application Priority Data
May 2, 2023 (KR) 10-2023-0057097

(51) Int. Cl. G10K 11/178

(52) U.S. Cl. CPC G10K 11/17827; G10K 11/17823; G10K 11/17873; G10K 2210/1282; G10K 2210/3011; G10K 2210/3016; G10K 2210/3027; G10K 2210/3056

(57) ABSTRACT

An active noise control method for a vehicle including: acquiring a noise signal near ears of a person seated in the vehicle; generating a first control signal for outputting a canceling sound having an anti-phase with respect to the noise signal; determining whether the noise signal contains an emergency sound; in response to determining that the noise signal contains the emergency sound, determining a frequency-specific gain corresponding to a sound pressure level of the emergency sound in the noise signal; generating a second control signal by applying the frequency-specific gain to the first control signal; and generating and outputting a first canceling sound based on the second control signal.

### CROSS-REFERENCE TO RELATED APPLICATIONS

The present application claims the benefit under 35 USC § 119 (a) of Patent Application No. 10-2023-0057097, filed on May 2, 2023, in Korea, the entire disclosure of which is incorporated herein by reference for all purposes.

### TECHNICAL FIELD

The present disclosure relates to an active noise control apparatus for a vehicle and a control method therefor.

### BACKGROUND

The content described in this section simply provides background information for the present disclosure and does not constitute related art.

While a vehicle is traveling, various noises are generated due to the air, a vehicle structure, or the like. For example, noise generated due to an engine of the vehicle, road noise generated due to friction between the vehicle and a road, wind noise generated due to wind, or the like may flow into a vehicle cabin.

In order to reduce such vehicle noise, an active noise control (ANC) technology for generating a canceling wave (anti-noise) having a phase opposite to that of the noise is being attempted.

One problem with an active noise control technology is that sounds in a targeted frequency band are all blocked. However, sounds heard by a driver during traveling of a vehicle are not only noise, but may sometimes be or include important sounds that need to be transferred to the driver. That is, when the active noise control technology is applied to a vehicle, there is concern that not only noise desired to be canceled out but also emergency sounds such as a siren sound of an ambulance or a police car that need to be transferred to the driver will be canceled out.

### SUMMARY

Therefore, there is a need for an active noise control method and apparatus capable of detecting an emergency sound that may be contained in noise flowing into a vehicle cabin and transferring the detected emergency sound to a driver.

According to the active noise control method and apparatus of the present disclosure, it is possible to transfer the emergency sound to the driver while canceling out, for example, a road noise contained in a sound flowing into the vehicle cabin.

### BRIEF DESCRIPTION OF THE DRAWINGS

FIG. 1 is a block diagram illustrating a configuration of an active noise control apparatus for a vehicle according to an embodiment of the present disclosure.

FIG. 2 is a flowchart illustrating an active noise control method of a vehicle according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

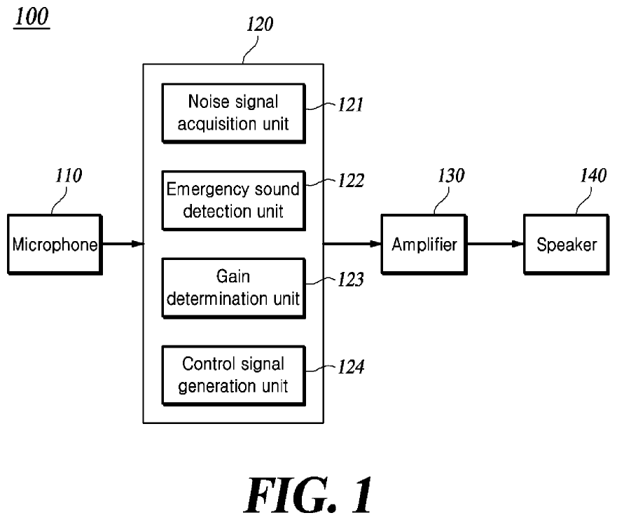

FIG. 1 is a block diagram illustrating a configuration of a vehicle active noise control apparatus according to an embodiment of the present disclosure.

To eliminate noise entering a cabin of a vehicle, the vehicle may include the active noise control apparatus. The active noise control apparatus can eliminate noise by generating a canceling sound with the same amplitude but an opposite phase (that is, anti-phase) with respect to the noise delivered to the driver in a vehicle cabin.

Referring to FIG. 1, the active noise control apparatus for a vehicle includes at least one microphone 110, an active noise controller 120, an amplifier 130, and at least one speaker 140. FIG. 1 illustrates one microphone and one speaker just for simplicity, but the active noise control apparatus typically uses a plurality of microphones and a plurality of speakers.

The microphone 110 may capture sounds inside the vehicle and transmit a noise signal to the active noise controller 120. The microphone 110 may be located on a headrest of a seat, a headliner of the vehicle, or another place suitable for capturing of noise that will be heard by occupants inside the vehicle. An array of a plurality of microphones may be used.

The active noise controller 120 may be implemented by a digital electronic circuit, an integrated circuit, a field programmable gate array (FPGA), an application specific integrated circuit (ASIC), or the like.

The active noise controller 120 generates a control signal for outputting a canceling sound having an anti-phase with respect to the noise signal, and outputs the canceling sound through the speaker 140 included in the vehicle on the basis of the control signal. The active noise controller 120 is an adaptive filter (often referred to as a W-filter) that is updated according to an algorithm such as least mean square (LMS) or filtered-x least mean square (FxLMS) well known in the art to generate the control signal.

The active noise controller 120 may decide whether or not an emergency sound is contained in the noise signal. When a decision is made that an emergency sound is contained in the noise signal, the active noise controller 120 may modify the control signal so that the emergency sound is not canceled out. In order to modify the control signal, the active noise controller 120 may determine a frequency-specific gain corresponding to the sound pressure level of the emergency sound in the noise signal. The active noise controller 120 may generate a modified control signal by applying the frequency-specific gain to the control signal.

The active noise controller 120 may transmit a control signal to an amplifier connected to the speaker to output the canceling sound through the speaker 140.

The active noise controller 120 may include, as functional configurations, a noise signal acquisition unit 121, an emergency sound detection unit 122, a gain determination unit 123, and a control signal generation unit 124.

The noise signal acquisition unit 121 receives the noise signal from the microphone 110.

The emergency sound detection unit 122 decides whether the emergency sound is contained in the noise signal. The emergency sound detection unit 122 may use a lookup table that defines sound pressure characteristics in an effective frequency band corresponding to each of a plurality of emergency sounds. The emergency sound detection unit 122 may perform frequency analysis on the noise signal to decide whether or not the noise signal conforms to the sound pressure characteristics of the corresponding emergency sound in the effective frequency band. In general, it is recommended that a siren exhibits a sound pressure of 90 dB or more and 120 dB or less at a position away 20 m. Sirens of a police car and a fire truck are known to have effective sound pressure in a frequency band of about 300 to 750 Hz, and a siren of an ambulance is known to have effective sound pressure in a frequency band of about 610 to 690 Hz.

The emergency sound detection unit 122 may also use a machine learning model to decide whether or not an emergency sound is contained in the noise signal. The machine learning model may be a classification model trained to classify an input sound signal as one of the plurality of emergency sounds. The emergency sound detection unit 122 provides the noise signal to the machine learning model to acquire an output of the machine learning model, and decides whether or not a sound conforming to the sound pressure characteristics of one of the plurality of emergency sounds is included in the noise signal on the basis of the output of the machine learning model.

The gain determination unit 123 determines the frequency-specific gain corresponding to the sound pressure level of the emergency sound in the noise signal. The frequency-specific gain may have values (for example, values smaller than “1”) inversely proportional to the sound pressure level of the emergency sound in the effective frequency band of the emergency sound, and have a constant value (for example, “1”) outside the effective frequency band.

The control signal generation unit 124 generates a first control signal for outputting a canceling sound having an anti-phase with respect to the noise signal. When the emergency sound detection unit 122 decides that an emergency sound is not contained in the noise signal, the control signal generation unit 124 transmits the first control signal to the amplifier 130 so that the canceling sound is output through the speaker 140 on the basis of the first control signal.

When the emergency sound detection unit 122 decides that an emergency sound is contained in the noise signal, the control signal generation unit 124 applies the frequency-specific gain determined by the gain determination unit 123 to the first control signal to generate a second control signal, and transmits the second control signal to the amplifier 130 so that the canceling sound is output through the speaker 140 on the basis of the second control signal.

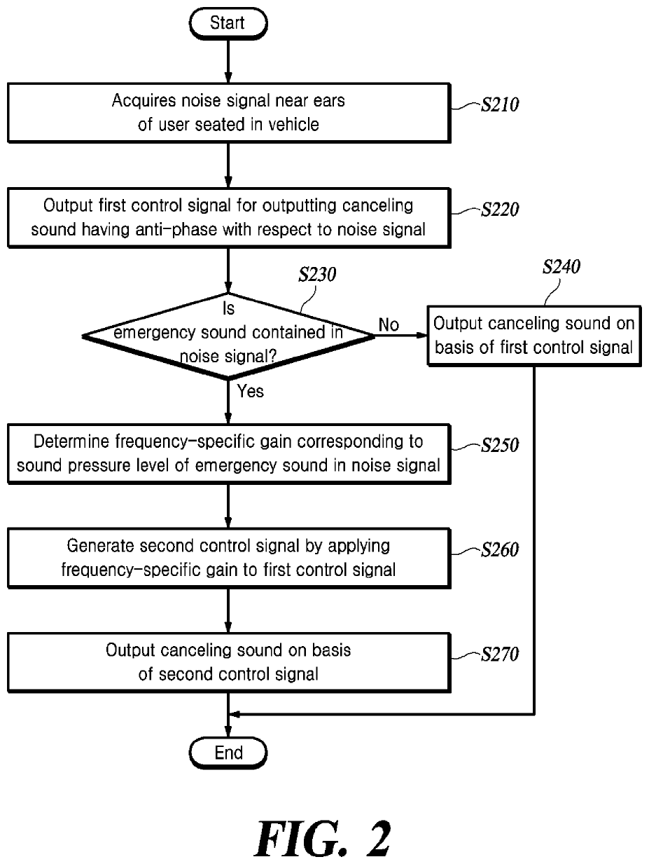

FIG. 2 is a flowchart illustrating an active noise control method for a vehicle according to an embodiment of the present disclosure.

Referring to FIG. 2, the active noise controller 120 acquires a noise signal near ears of a user (or person) seated in the vehicle (S210).

The active noise controller 120 generates a first control signal for outputting a canceling sound having an anti-phase with respect to the noise signal (S220).

The active noise controller 120 decides whether or not an emergency sound is contained in the noise signal (S230). In order to decide whether or not an emergency sound is contained in the noise signal, the active noise controller 120 may perform frequency analysis on the noise signal on the basis of a lookup table that defines the sound pressure characteristics in the effective frequency band corresponding to each of a plurality of emergency sounds. The active noise controller 120 may decide whether the noise signal conforms to the sound pressure characteristics of the corresponding emergency sound in the effective frequency band.

Alternatively, the active noise controller 120 may provide the noise signal to a machine learning model to acquire an output of the machine learning model, and decide whether one of the plurality of emergency sounds is contained in the noise signal, on the basis of the output of the machine learning model. The machine learning model may be a classification model that classifies the input sound signal into one of the plurality of emergency sounds.

When a decision is made in step S230 that the emergency sound is not contained in the noise signal, the active noise controller 120 outputs a canceling sound on the basis of the first control signal (S240).

In step S230, when a decision is made that an emergency sound is contained in the noise signal, the active noise controller 120 determines the frequency-specific gain corresponding to the sound pressure level of the emergency sound in the noise signal (S250). Here, the frequency-specific gain may be inversely proportional to the sound pressure level of the emergency sound in the effective frequency band of the emergency sound, and may have a constant value outside the effective frequency band.

The active noise controller 120 generates a second control signal by applying the frequency-specific gain to the first control signal (S260).

The active noise controller 120 outputs the canceling sound on the basis of the second control signal (S270).

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An active noise control method for a vehicle, comprising:
acquiring a noise signal near ears of a person seated in the vehicle;
generating a first control signal for outputting a canceling sound having an anti-phase with respect to the noise signal;
determining whether the noise signal contains an emergency sound;
in response to determining that the noise signal contains the emergency sound, determining a frequency-specific gain corresponding to a sound pressure level of the emergency sound in the noise signal;
generating a second control signal by applying the frequency-specific gain to the first control signal; and
generating and outputting a first canceling sound based on the second control signal.

2. The active noise control method of claim 1, further comprising, in response to determining that the noise signal does not contain the emergency sound, outputting a second canceling sound based on the first control signal.

3. The active noise control method of claim 1, wherein the frequency-specific gain is inversely proportional to the sound pressure level of the emergency sound in an effective frequency band of the emergency sound and has a constant value outside the effective frequency band of the emergency sound.

4. The active noise control method of claim 1, wherein determining whether the noise signal contains the emergency sound comprises:
performing frequency analysis on the noise signal based on a lookup table that defines sound pressure characteristics in an effective frequency band corresponding to each of a plurality of emergency sound types; and
determining whether the noise signal conforms to the sound pressure characteristics of the corresponding emergency sound type in the effective frequency band.

5. The active noise control method of claim 1, wherein determining whether the noise signal contains the emergency sound includes:
providing the noise signal to a machine learning model and acquiring an output of the machine learning model, the machine learning model including a classification model that classifies the input sound signal into one of a plurality of emergency sounds; and
deciding whether one of the plurality of emergency sounds is contained in the noise signal based on the output of the machine learning model.

6. An active noise control apparatus for a vehicle, comprising:
a microphone disposed near ears of a person seated in the vehicle to acquire a noise signal;
an active noise controller configured to generate a control signal for outputting a canceling sound having an anti-phase with respect to the noise signal; and
a speaker configured to output the canceling sound.

7. The active noise control apparatus of claim 6, wherein the active noise controller includes:
a noise signal acquisition unit configured to receive the noise signal from the microphone;
an emergency sound detection unit configured to decide whether the noise signal contains an emergency sound;
a gain determination unit configured to determine a frequency-specific gain corresponding to a sound pressure level of the emergency sound contained in the noise signal; and
a control signal generation unit configured to generate one of first and second control signals for outputting the canceling sound having the anti-phase with respect to the noise signal.

8. The active noise control apparatus for a vehicle of claim 7, wherein the emergency sound detection unit is configured to provide the noise signal to a machine learning model, acquire an output of the machine learning model, and determine whether the noise signal contains one of a plurality of emergency sounds based on the output of the machine learning model.

9. The active noise control apparatus of claim 7, wherein the control signal generation unit is configured to apply the frequency-specific gain determined by the gain determination unit to the first control signal to generate the second control signal in response to the emergency sound detection unit determining that the noise signal contains the emergency sound.

10. The active noise control apparatus of claim 7, wherein the emergency sound detection unit is configured to:
perform frequency analysis on the noise signal based on a lookup table that defines sound pressure characteristics in an effective frequency band corresponding to each of a plurality of emergency sounds; and
determine whether the noise signal conforms to the sound pressure characteristics of the corresponding emergency sound in the effective frequency band.
